(19) United States
(12) Patent Application Publication
(10) Pub. No.: US 2005/0242467 A1
(43) Pub. Date: Nov. 3, 2005

(54) Method of fabricating a structural part of a motor vehicle, a structural part, a front panel cross-member, and a bumper beam

(75) Inventors: Gerald Andre, Amberieu en Bugey (FR); Eric Bonneau, St Romain de Jalionas (FR); Hugues Cheron, Meximieux (FR); Thibault Lacroix, Chateau-Gaillard (FR)

Correspondence Address: James R. Williams;Jamison, Seltzer, Harper & Williams, 2625 Wilmington Road, New Castle, PA, 16105, US

(73) Assignee: Compagnie Plastic Omnium, Lyon (FR)

(21) Appl. No.: 11/027,554

(22) Filed: Dec. 30, 2004

(30) Foreign Application Priority Data
Jan. 2, 2004 (FR) 0400013

(51) Int. Cl. B29C 39/10

(52) U.S. Cl. 264/255; 264/259; 264/265

(57) ABSTRACT

The present invention relates to a method of fabricating a motor vehicle structural part comprising a metal sheet stabilized by a mechanical stabilizer element of thermoplastic material. The method comprises the following steps: shaping the metal sheet that has previously been coated in a surface covering serving as a mechanical bonding interface with the thermoplastic material of the mechanical stabilizer element, the surface covering being made of a material including a substance compatible with the thermoplastic material of the stabilizer element; and applying thereto the thermoplastic material constituting the mechanical stabilizer element. The invention also provides a structural part fabricated by implementing such a method.

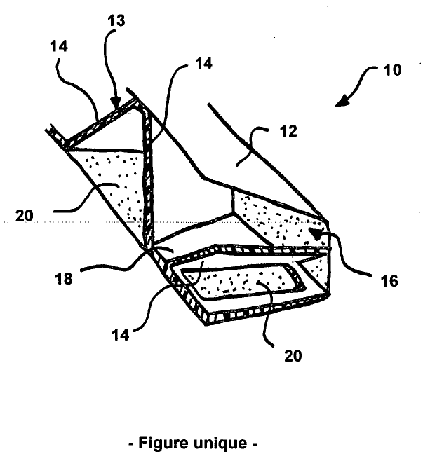

The present invention relates to a method of fabricating a structural part of a motor vehicle, to a structural part, to a front end module cross-member, and to a bumper beam.

### BACKGROUND OF THE INVENTION

Present requirements in the automobile field are leading manufacturers to use structural parts that are both rigid in order to increase passenger safety, and lightweight in order to limit the weight of the vehicle and thus the cost of using it.

In the state of the art, such a structural part is already known, such as a bumper beam which combines the rigidity of metal materials with the light weight of plastics material. To do this, such a “hybrid” beam is made up of a stamped sheet of metal assembled with a mechanical stabilizer element of thermoplastics material, such as a set of stiffening ribs.

Generally, the plastics material and the sheet metal are united by through connections which may be constituted by portions of plastics material obtained by overmolding the plastics material on the sheet metal, as in EP 0 370 342 and FR 2 781 713, or by snap-fastening as in FR 2 800 030.

The problem with that type of beam lies in assembling the sheet metal and the plastics material requires through orifices to be made in one of the two materials. These orifices weaken the sheet metal or the stabilizer element made of plastics material, particularly since the connection between the sheet metal and the plastics material takes place via point locations only.

One solution might be to bond the stabilizer element of plastics material to the sheet metal using adhesive so as to obtain a continuous connection. Nevertheless, that method is not used because of the difficulty of reaching the inside of the stamped sheet metal and because of the additional costs involved with putting adhesive into precise locations.

### OBJECTS AND SUMMARY OF THE INVENTION

The present invention seeks to remedy those drawbacks by proposing a method of fabricating a motor vehicle structural part in which the metal and the plastics material are assembled together without making a hole in the metal sheet or in the thermoplastic material, while also simplifying the assembly operation.

To this end, the invention provides a method of fabricating a structural part for a motor vehicle, the part comprising a metal sheet stabilized by a mechanical stabilizer element of thermoplastic material, the method comprising the following steps:
shaping the metal sheet that has previously been coated in a surface covering serving as a mechanical bonding interface with the thermoplastic material of the mechanical stabilizer element, the surface covering being made of a material including a substance compatible with the thermoplastic material of the stabilizer element; and
applying thereto the thermoplastic material constituting the mechanical stabilizer element.

Thus, such a method makes it possible to obtain a hybrid structural part in which neither the metal sheet nor the stabilizer element are pierced. In addition, because of the surface covering, the bond between the metal sheet and the stabilizer element of plastics material is continuous, and thus improved.

The term “stabilizer element” is used to mean an element serving to limit the stresses that the metal sheet needs to withstand when subjected to bending or twisting. By way of example, the stabilizer element may comprise a stiffening rib, or a layer of plastics material.

In a preferred implementation of the invention, shaping the metal sheet includes a step of folding or stamping.

Optionally, the thermoplastic material is applied by overmolding the pre-coated sheet. Thus, unlike through connections which require some minimum quantity of thermoplastic material for each connection point in order to ensure sufficient connection strength, the method of the invention makes it possible to provide a quantity of material that is exactly sufficient for mechanically stabilizing the metal sheet at a specific location, and to do so at low cost.

In an implementation, the surface covering is made of a material that is reactivatable, preferably when hot. Thus, the material reacts only above a certain temperature, such as the temperature at which the thermoplastic material for the stiffening rib is injected, thus enabling the metal sheet to be shaped without its surface covering sticking to the shaping tools.

In a first implementation, the prior operation of coating the metal sheet with the surface covering is performed separately, as soon as the metal sheet has been fabricated, e.g. in the form of sheet metal. The pre-coated sheet metal is subsequently shaped, and the thermoplastic material is applied to the shaped pre-coated sheet metal in accordance with the invention.

In a second implementation, prior coating is performed immediately before the sheet is shaped.

Optionally, the metal sheet coated with the surface covering includes an area, referred to as a free area, that is not covered by the stabilizer element of thermoplastic material. This free area can serve as a connection interface for a component other than the stabilizer element. It is thus possible, by reactivating the free area again, to cause it to react in such a manner that the surface covering can serve as means for fastening other components, such as components that are provided as options depending on the vehicle.

The structural part of the invention may further comprise one or more of the following characteristics:
the surface covering and the stabilizer element include a substance in common;
the surface covering comprises a binder and, on its side remote from the metal sheet, a film of thermoplastic material made out of the same material as the stabilizer element, so as to encourage adhesion between the stabilizer element and the surface covering;
the stabilizer element is made of polypropylene or polyamide; and
the surface covering comprises polypropylene or polyamide.

The invention also provides a motor vehicle structural part obtained by implementing a method of the above-specified type, e.g. a front end module cross-member or a bumper beam.

### BRIEF DESCRIPTION OF THE DRAWING

The invention will be better understood on reading the following description given purely by way of example and made with reference to the sole accompanying FIGURE which is a perspective view of a portion of a structural part in accordance with the invention.

### MORE DETAILED DESCRIPTION

The structural part shown in the sole figure is a front or rear bumper beam 10. The beam 10 comprises a metal sheet 12 of channel-section made by stamping sheet metal.

The beam 10 also includes, inside the channel-section, a stabilizer element 13 made of a thermoplastic material such as polypropylene, and serving to limit the stresses that the metal sheet 12 needs to withstand in the event of being subjected to bending or twisting. The stabilizer element 13 shown in the figure comprises both stiffening ribs 14 crossing the inside of the sheet 12, and stabilizer zones 18 arranged as extra thickness inside the sheet 12.

In other embodiments, the thermoplastic stabilizer element comprises solely stiffener ribs or solely a layer of extra thickness, which may be uniform or non-uniform.

Because of the two components 12 and 13 being made of different materials, the beam 10 offers a good inertia and good twisting strength, while being sufficiently lightweight.

In order to bond the sheet 12 and the stabilizer element 13 together, the sheet 12 is covered by a surface covering 16 serving as the mechanical connection interface with the element 13.

The surface covering 16 is made of a material that presents the following characteristics:
it is thermo-reactive, i.e. it acquires adhesive properties at a certain temperature;
it is suitable for bonding with metals, such as the adhesives that are known in the state of the art for bonding together metal structural parts such as the hood and the hood liner, or the tailgate and the tailgate liner, in particular of the kind sold by the supplier Henkel; and
it contains polypropylene.

The metal sheet 12 and the stabilizer element 13 are assembled together as follows.

Initially, at least the entire inside surface of the metal sheet is pre-coated with the surface covering 16. This first step is performed as soon as the sheet metal is fabricated, prior to being sold.

In a second step, the sheet 12, already pre-coated with the covering 16, is cut and shaped by stamping or folding so as to take up the channel-section shape shown in the drawing.

In a third step, the sheet metal as prepared in this way is placed in a mold into which polypropylene is injected so as to form the ribs 14 of plastics material, and also the stabilizer zones 18.

During this molding operation, the polypropylene is injected at a temperature that is relatively high so that it is liquid. This temperature is also sufficiently high to cause the material constituting the interface layer 16 to react.

Furthermore, since the surface covering material 16 includes polypropylene, it is compatible with the polypropylene that is injected to mold the element 13.

Consequently, when the polypropylene comes into contact with the surface covering 16 inside the mold, the covering reacts so as to create a bond between the element 13 and the metal sheet 12.

As can be seen on the beam 10 as obtained after injection, stabilizer zones 18 are thus obtained in which the interface layer 16 and the injected thermoplastic material have fused together so as to provide a continuous connection between the plastics material and the metal sheet 12, thereby stabilizing the sheet 12.

Optionally, and in an embodiment that is not shown, the surface covering 16 is covered, prior to overmolding, in a film of polypropylene so as to encourage the polypropylene constituting the stiffening ribs to bond onto the metal sheet.

Furthermore, it can be seen that since the sheet 12 is pre-coated over the entire surface of the covering 16, certain areas that were not covered in plastics material during injection have not reacted and are not covered by the plastics material. Consequently, these areas 20 remain free, and since they carry the surface covering 16 they can be reactivated by heat so as to fasten a component on the structural part, e.g. an air guide, fastening tabs (for parts that are fastened as options on the vehicle), a horn, . . . .

It should be observed that the invention is not limited to the embodiment described.

In particular, obtaining a bond between the plastics material and the metal sheet 12 need not occur solely by the overmolding operation, but may also include an assembly operation.

Finally, a structural part as described may be used in a vehicle for parts other than a beam 10, for example a front end module cross-member, an upright, a side rail, a roof structural part, a low pedestrian shield, a pillar or a cross-member for a door-bay, a scuttle support, an underbody flap.

1. A method of fabricating a structural part of a motor vehicle, the part comprising a metal sheet stabilized by a mechanical stabilizer element of thermoplastic material, the method comprising the following steps:
a) shaping the metal sheet that has previously been coated with a surface covering serving as a mechanical bonding interface with the thermoplastic material of the mechanical stabilizer element, the surface covering being made of a material including a substance compatible with the thermoplastic material of the stabilizer element; and
b) applying thereto the thermoplastic material constituting the mechanical stabilizer element.

2. A method according to claim 1, in which the stabilizer element comprises a stiffener rib.

3. A method according to claim 1, in which the stabilizer element comprises a layer of plastics material.

4. A method according to claim 1, in which shaping the metal sheet includes a step of folding or stamping.

5. A method according to claim 1, in which the thermoplastic material is applied by being overmolded onto the pre-coated sheet.

6. A method according to claim 1, in which the surface covering is made of a reactivatable material.

7. A method according to claim 1, in which the surface covering and the stabilizer element include a substance in common.

8. A method according to claim 1, in which the surface covering comprises a binder, and on a side opposite from the metal sheet a film of thermoplastic material comprises a same material as the stabilizer element, so as to encourage adhesion of the stabilizer element on the surface covering.

9. A method according to claim 1, in which the stabilizer element is is selected from a group consisting of polypropylene and polyamide.

10. A method according to claim 1, in which the surface covering comprises a material selected from a group consisting of polypropylene and polyamide.

11. A method according to claim 1, in which the metal sheet coated with the surface covering includes a free area that is not covered by the stabilizer element of thermoplastic material.

12. A method according to claim 11, in which the free area serves as a bonding interface with a component other than the stabilizer element.

13. A method according to claim 1, in which the prior coating of the metal sheet with the surface covering is performed as soon as the metal sheet is fabricated.

14. A method according to claim 1, in which the prior coating of the metal sheet with the surface covering is performed immediately prior to shaping the metal sheet.

15. A motor vehicle structural part comprising a metal sheet stabilized by a mechanical stabilizer element of thermoplastic material, the part fabricated by:
a) shaping the metal sheet that has previously been coated with a surface covering serving as a mechanical bonding interface with the thermoplastic material of the mechanical stabilizer element the surface covering being made of a material including a substance compatible with the thermoplastic material of the stabilizer element; and
b) applying thereto the thermoplastic material constituting the mechanical stabilizer element.

16-17. (canceled)

18. The motor vehicle structural part of claim 15, wherein the part is selected from a group consisting of a front end module cross-member and a bumper beam.
